(19) United States
(12) Patent Application Publication
(10) Pub. No.: US 2005/0172571 A1
(43) Pub. Date: Aug. 11, 2005

(54) Molding member having planar portion tacked to ceiling or wall surface by sealant or caulk

(75) Inventors: Joseph M. Koenig JR., Glenview, IL (US); Mark Budzik, Des Plaines, IL (US)

Correspondence Address: WOOD, PHILLIPS, KATZ, CLARK & MORTIMER, 500 W. MADISON STREET, SUITE 3800, CHICAGO, IL, 60661, US

(73) Assignee: Trim-Tex, Inc.

(21) Appl. No.: 11/088,451

(22) Filed: Mar. 24, 2005

Related U.S. Application Data
(63) Continuation-in-part of application No. 10/850,225, filed on May 20, 2004.
Application No. 10/850,225 is a continuation-in-part of application No. 10/774,798, filed on Feb. 9, 2004.

(51) Int. Cl. F21S 8/00

(52) U.S. Cl. 52/718.01

(57) ABSTRACT

When a molding member comprising a planar portion, an intermediate portion, and a mounting flange, is installed in a room having a ceiling and having walls, a sealant or a caulk is used for tacking the planar portion to a ceiling or wall surface of the room, along with an adhesive, mechanical fasteners, or both for mounting the mounting flange to a ceiling or wall surface of the room. The planar portion does not have to be otherwise attached to the ceiling or wall surface to which the planar portion is tacked. The mounting flange has apertures, through which drywall-finishing material is pressed against the ceiling or wall surface to which the mounting flange is mounted. The planar portion and the mounting flange have respective ceiling-facing or wall-facing surfaces, which may be coplanar, which may be parallel but not coplanar, or which may be oriented at a right angle relative to each other or at another angle relative to each other.

### CROSS-REFERENCE TO RELATED APPLICATIONS

This application is a continuation-in-part of U.S. patent application Ser. No. 10/850,225, which was filed on May 20, 2004, and the disclosure of which is incorporated herein by reference. U.S. patent application Ser. No. 10/850,225 is a continuation-in-part of U.S. patent application Ser. No. 10/774,798, which was filed on Feb. 9, 2004, and the disclosure of which is incorporated herein by reference.

### BACKGROUND OF THE INVENTION

In U.S. patent applications Ser. No. 10/850,225 and Ser. No. 10/774,798, supra, a crown molding member is disclosed, which is used to trim a corner where a wall and a ceiling meet. The crown molding member has a planar portion, which is a attached to the ceiling, in a first mode, or to the wall, in a second mode. The crown molding member has an intermediate portion, which may have a coved, stepped, or curved profile. The crown molding member has a mounting flange, which is attached to the wall, in the first mode, or to the ceiling, in the second mode. The mounting flange may be so attached by an adhesive, by mechanical fasteners, such as staples, or by both. The mounting flange has apertures, through which drywall-finishing material, so-called “mud” in trade parlance, may be then pressed against the wall, in the first mode, or against the ceiling, in the second mode.

An implementation embodying and exemplifying but not limiting this invention is illustrated in FIG. 8, which is common to U.S. patent applications Ser. No. 10/850,225 and Ser. No. 10/774,798, supra. As illustrated therein, a caulk bead is applied along the crown molding member, where a first edge of the intermediate portion adjoins a first edge of the planar portion, so as to adhere to a horizontal ceiling, after the crown molding member has been installed.

### SUMMARY OF THE INVENTION

This invention provides, in a room having a ceiling and having walls, a molding member comprising a planar portion, an intermediate portion, and a mounting flange, wherein the planar portion and the mounting flange extend respectively from opposite edges of the intermediate portion, as combined with means comprising a sealant or a caulk for tacking the planar portion to a ceiling or wall surface.

The molding member may be also combined with means comprising an adhesive, mechanical fasteners, or both for mounting the mounting flange to a ceiling or wall surface. The mounting flange may have apertures, through which drywall-finishing material, so-called “mud” in trade parlance, may be then pressed against the ceiling or wall surface to which the mounting portion is mounted.

In certain contemplated embodiments, such as the crown molding member illustrated in FIG. 8 common to U.S. patent applications Ser. No. 10/850,225 and Ser. No. 10/774,798, supra, the planar portion and the mounting flange have respective, ceiling-facing or wall-facing surfaces, which are oriented at a right angle relative to each other.

In other contemplated embodiments, the planar portion and the mounting flange have respective ceiling-facing or wall-facing surfaces, which are oriented at a different (i.e. non-right) angle relative to each other. In other contemplated embodiments, such as a chair railing member, the planar portion and the mounting flange have respective ceiling-facing or wall-facing surfaces, which are coplanar. In other contemplated embodiments, such as an L-bead, the planar portion and the mounting flange have respective ceiling-facing or wall-facing surfaces, which are parallel but not coplanar.

### BRIEF DESCRIPTION OF THE DRAWINGS

FIG. 1, which is similar to FIG. 8 common to U.S. patent applications Ser. No. 10/850,225 and Ser. No. 10/774,798, supra, is a sectional view showing a crown molding member, as used to trim a corner where a wall and a ceiling meet. As shown in FIG. 1, a sealant or caulk bead applied along the crown molding member, where a planar portion of the crown molding member and an intermediate portion of the crown molding member meet, is used to tack the planar portion to a ceiling surface.

FIGS. 2 and 3 are enlarged details showing successive steps in an alternative mode wherein a sealant or caulk stripe is applied along a ceiling-facing surface of the planar portion, as shown in FIG. 2, and wherein the sealant or caulk stripe is compressed between the planar portion and the ceiling surface, as shown in FIG. 3. As outlined in broken lines in FIG. 3, an extruded portion of the sealant or caulk stripe is spread, as by an index finger being pulled along the crown molding member, in the alternative mode.

FIGS. 4, 5, and 6 are sectional views showing successive steps in installing a chair railing member, which is used to trim a wall. As compared to FIGS. 4 and 5, FIG. 6 is enlarged. FIGS. 7, 8, and 9 are sectional views showing successive steps in installing an L-bead, which is used to trim a wall where two drywall panels have been mounted, in a stack, to a wall. As compared to FIGS. 7 and 8, FIG. 9 is enlarged.

### DETAILED DESCRIPTION OF THE ILLUSTRATED EMBODIMENTS

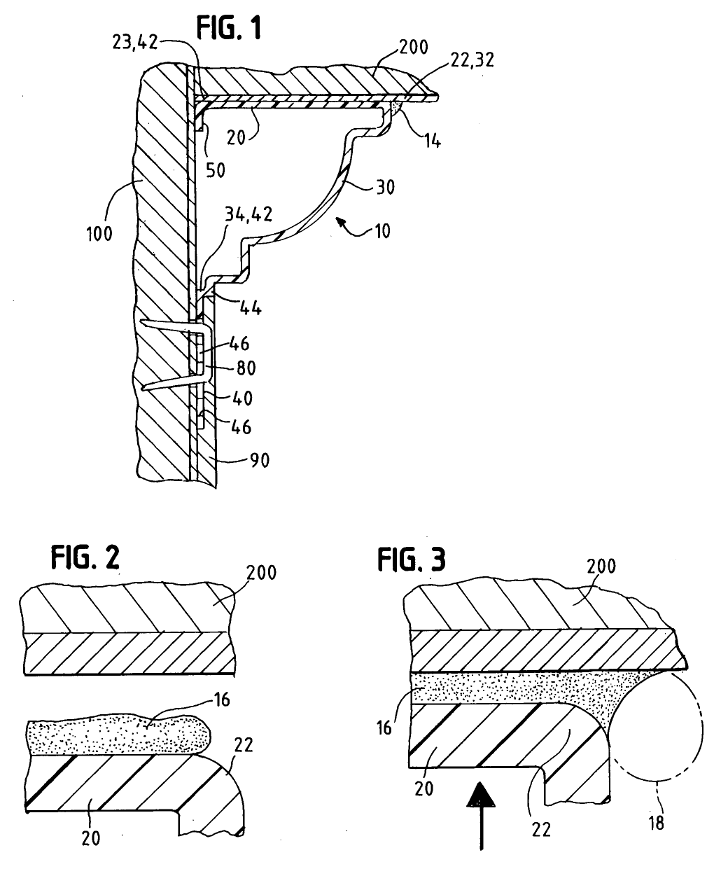

As illustrated in FIG. 1, a crown molding member 10 embodying this invention has a planar portion 20, which has a first edge 22 and a second edge 24, an intermediate portion 30, which has a first edge 32 adjoining the first edge 22 of the planar portion 20 and which has a second edge 34 spaced from the first edge 32 of the intermediate portion 30, a mounting flange 40 having an adjoining edge 42 adjoining the first edge 34 of the intermediate portion 30, and an additional flange 50 having an adjoining edge 54 adjoining the second edge 24 of the planar portion 20. The planar portion 20 and the mounting flange 40 project at a right angle relative to each other.

The intermediate portion 30 may have a coved, curved, or stepped profile or an arbitrary profile. A step 44 is defined where the adjoining edge 42 of the mounting flange 40 adjoins the second edge 34 of the intermediate portion 30. The mounting flange 40 has an array of apertures 46, such as circular holes, which are illustrated, or such as elongate slots.

Preferably, the crown molding member 10 is extruded so as to have a substantially uniform thickness of approximately 0.060 inch to approximately 0.070 inch, from a suitable, polymeric material, such as polyvinyl chloride having a hardness of Durometer Shore 82 D.

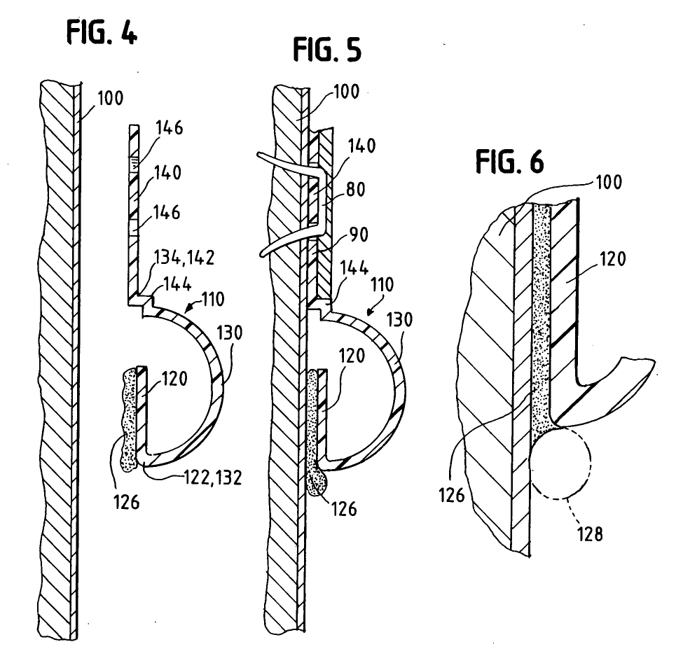

As illustrated in FIG. 2, the crown molding member 10 is installed in a preferred mode, so as to trim an interior corner where a vertical wall 100 and a horizontal ceiling 200 meet. The vertical wall 100 and the horizontal ceiling 200 are defined by drywall panels having gypsum cores and having paper faces. The planar portion 20 extends horizontally, beneath and along the horizontal ceiling 200, to which the planar portion 20 is tacked, in a manner discussed below. The mounting flange 40 extends vertically, against and along the vertical wall 100, to which the mounting flange is attached, in a manner discussed below.

As illustrated in FIG. 2, the second edge 24 of the planar portion 20 is proximal to the vertical wall 100. Also, the additional flange 50 extends along the vertical wall 100, toward the mounting flange 40. Also, the mounting flange 40 extends downwardly, along the vertical wall 100, away from the horizontal ceiling 200. Moreover, the additional flange 50 extends downwardly, beside and along the vertical wall 100, toward the mounting flange 40.

As illustrated in FIG. 2, the mounting flange 40 is attached to the vertical wall 100 via mechanical fasteners 80, such as wire staples with diverging legs, one such staple being shown. Moreover, when drywall-finishing material 90, so-called “mud” in trade parlance, is applied to the mounting flange 40, some of the applied material 90 can be then pressed through at least some of the apertures 46, against the vertical wall 100. The step 44 facilitates spreading of such material 90 with a drywall-finishing blade.

Furthermore, a sealant or caulk bead 14 is applied along the crown molding member 10, where the first edge 32 of the intermediate portion 30 adjoins the first edge 22 of the planar portion 20, so as to tack the planar portion 20 to the horizontal ceiling 200. Advantageously, there is no need for the planar portion 20 to be adhesively or mechanically attached to the horizontal ceiling 200, except via the sealant or caulk bead 14.

In the alternative mode shown in FIGS. 2 and 3, the sealant or caulk bead 14 is not used but a sealant or caulk stripe 16 is applied along the planar portion 20, near the first edge 22, between the planar portion 20 and the horizontal ceiling 200, whereupon the sealant or caulk stripe 16 is compressed therebetween, so as to tack the planar portion 20 to the horizontal ceiling 200 and so as to extrude a portion 18 of the sealant or caulk stripe 16 beyond the first edge 22. As outlined in broken lines in FIG. 3, the extruded portion 18 of the sealant or caulk stripe 16 is spread, as by an index finger being pulled along the crown molding member 10.

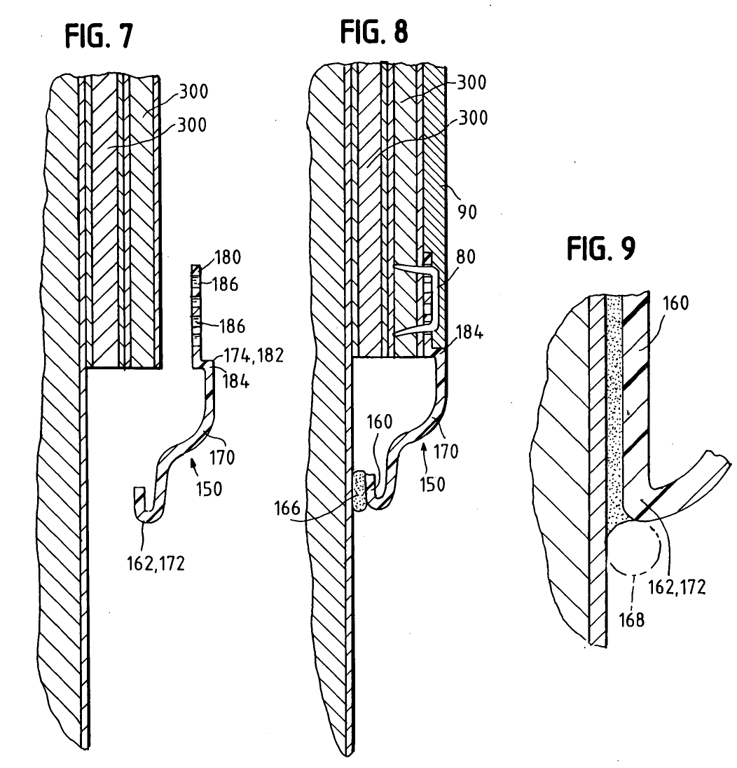

As illustrated in FIGS. 4, 5, and 6, a chair railing member 110 has a planar portion 120, which has a first edge 122 and a second edge 124, an intermediate portion 130, which has a first edge 132 adjoining the first edge 122 of the planar portion 120 and which has a second edge 134 spaced from the first edge 132 of the intermediate portion 130, and a mounting flange 140 having an adjoining edge 142 adjoining the first edge 134 of the intermediate portion 130, which has a concave profile.

The planar portion 120 and the mounting flange 140 are coplanar. The planar portion 120 extends toward the mounting flange 140 so that, when the chair railing member 110 is installed, the planar portion 120 is concealed by the intermediate portion 130. A step 144 is defined where the adjoining edge 142 of the mounting flange 140 adjoins the second edge 134 of the intermediate portion 130. The mounting flange 140 has an array of apertures 146, such as circular holes, which are illustrated, or such as elongate slots.

As illustrated in FIG. 5, the mounting flange 140 is attached to the vertical wall 100 via mechanical fasteners 80, such as wire staples with diverging legs, one such staple being shown. Moreover, when drywall-finishing material 90, so-called “mud” in trade parlance, is applied to the mounting flange 140, some of the applied material 90 can be then pressed through at least some of the apertures 146, against the vertical wall 100. The step 144 facilitates spreading of such material 90 with a drywall-finishing blade.

As shown in FIGS. 4, 5, and 6, a sealant or caulk stripe 126 is applied along the planar portion 120, near the first edge 122, between the planar portion 120 and the vertical wall 100, whereupon the sealant or caulk stripe 126 is compressed therebetween, so as to tack the planar portion 120 to the vertical wall 100 and so as to extrude a portion 128 of the sealant or caulk stripe 126 beyond the first edge 122. As outlined in broken lines in FIG. 6, the extruded portion 128 of the sealant or caulk stripe 126 is spread, as by an index finger being pulled along the chair railing member 110.

As illustrated in FIGS. 7, 8, and 9, an L-bead 150 has a planar portion 160, which has a first edge 162 and a second edge 164, an intermediate portion 170, which has a first edge 172 adjoining the first edge 162 of the planar portion 160 and which has a second edge 174 spaced from the first edge 172 of the intermediate portion 170, and a mounting flange 180 having an adjoining edge 182 adjoining the first edge 174 of the intermediate portion 170, which has a concave profile.

As illustrated in FIGS. 7, 8, and 9, the L-bead 150 is used to trim the lower edges of two drywall panels 300, which are mounted adhesively, via mechanical fasteners, or adhesively and via mechanical fasteners to the vertical wall 100. If the L-bead were to be differently proportioned, the L-bead could be instead used to trim the lower edge of one drywall panel, which is mounted similarly to a vertical wall.

The planar portion 160 and the mounting portion 180 are parallel but not coplanar. A step 184 is defined where the adjoining edge 142 of the mounting flange 180 adjoins the second edge 174 of the intermediate portion 170. The mounting flange 180 has an array of apertures 186, such as circular holes, which are illustrated, or such as elongate slots.

As illustrated in FIG. 8, the mounting flange 180 is attached to whichever one of the drywall panels 300 is farther from the vertical wall 100 via mechanical fasteners 80, such as wire staples with diverging legs, one such staple being shown. Moreover, when drywall-finishing material 90, so-called “mud” in trade parlance, is applied to the mounting flange 180, some of the applied material 90 can be then pressed through at least some of the apertures 186, against the same one of the drywall panels 300. The step 184 facilitates spreading of such material 90 with a drywall-finishing blade.

As shown in FIGS. 7, 8, and 9, a sealant or caulk stripe 166 is applied along the planar portion 160, near the first edge 162, between the planar portion 160 and the vertical wall 100, whereupon the sealant or caulk stripe 166 is compressed therebetween, so as to tack the planar portion 160 to the vertical wall 100 and so as to extrude a portion 168 of the sealant or caulk stripe 166 beyond the first edge 162. As outlined in broken lines in FIG. 6, the extruded portion 168 of the sealant or caulk stripe 166 is spread, as by an index finger being pulled along the L-bead 150.

The crown molding member 10 exemplifies a molding member embodying this invention, wherein the planar portion of the molding member and the mounting flange of the molding member have respective ceiling-facing or wall-facing surfaces, which are oriented at a right angle relative to each other. The chair railing member 110 exemplifies a molding member embodying this invention, wherein the planar portion of the molding member and the mounting flange of the molding member have respective, ceiling-facing or wall-facing surfaces, which are coplanar. The 1-bead 140 exemplifies a molding member embodying this invention, wherein the planar portion of the molding member and the mounting flange of the molding member have respective, ceiling-facing or wall-facing surfaces, which are parallel but not coplanar.

Where a sealant or a caulk is specified herein, a siliconized acrylic latex caulk is suitable, which is available commercially from numerous sources including DAP Brands Company of Baltimore, Md. Trim-Tex, Inc. of Lincolnwood, Ill., is about to introduce, for commercial sale, Trim-Tex™ 710™ Caulk, which will be also suitable.

1. In a room having a ceiling and having walls, a molding member comprising a planar portion, an intermediate portion, and a mounting flange, wherein the planar portion and the mounting flange extend respectively from opposite edges of the intermediate portion, as combined with means comprising a sealant or a caulk for tacking the planar portion to a ceiling or wall surface.

2. In a room having a ceiling and having walls, a molding member comprising a planar portion, an intermediate portion, and a mounting flange, wherein the planar portion and the mounting flange extend respectively from opposite edges of the intermediate portion, as combined with means comprising a sealant or a caulk for tacking the planar portion to a ceiling or wall surface and with means comprising an adhesive, mechanical fasteners, or both for mounting the mounting flange to a ceiling or wall surface.

3. In a room having a ceiling and having walls, a molding member comprising a planar portion, an intermediate portion, and a mounting flange, wherein the planar portion and the mounting flange extend respectively from opposite edges of the intermediate portion, as installed in a room by means comprising a sealant or a caulk for tacking the planar portion to a ceiling or wall surface of the room and by means comprising an adhesive, mechanical fasteners, or both for mounting the mounting flange to a ceiling or wall surface of the room, the mounting flange having apertures, through which drywall-finishing material is pressed against the ceiling or wall surface to which the mounting flange is mounted.

4. The molding member of claim 1, 2, or 3, wherein the planar portion and the mounting flange have respective ceiling-facing or wall-facing surfaces, which are coplanar.

5. The molding member of claim 1, 2, or 3, wherein the planar portion and the mounting flange have respective ceiling-facing or wall-facing surfaces, which are parallel but not coplanar.

6. The molding member of claim 1, 2, or 3, wherein the planar portion and the mounting flange have respective ceiling-facing or wall-facing surfaces, which are oriented at an angle relative to each other.

7. The molding member of claim 1, 2, or 3, wherein the planar portion and the mounting flange have respective ceiling-facing or wall-facing surfaces, which are oriented at a right angle relative to each other.
